(19) United States
(12) Patent Application Publication
(10) Pub. No.: US 2003/0111578 A1
(43) Pub. Date: Jun. 19, 2003

(54) Kite and selling method of kite

(76) Inventors: Toshio Ito, Tokyo (JP); Katsuhisa Ohtsuta, Tokyo (JP); Kazuo Mori, Itami (JP)

Correspondence Address: WENDEROTH, LIND & PONACK, L.L.P., 2033 K STREET N. W., SUITE 800, WASHINGTON, DC, 20006-1021, US

(21) Appl. No.: 10/320,662

(22) Filed: Dec. 17, 2002

(30) Foreign Application Priority Data
Dec. 18, 2001 (JP) 2001-384423
Oct. 10, 2002 (JP) 2002-296887

(51) Int. Cl. F41J 9/08; A63H 27/08; B64C 31/06

(52) U.S. Cl. 244/153 R

(57) ABSTRACT

A kit of a kite packs all necessary parts for assembling of a kite. The kite can be constructed by pasting a spine serving as the kite's axis of symmetry, main beams of the wing with the spring holder disposed at the position higher (upstream) than the aerodynamic center of the wing and orthogonal to the spine, and slant beams inclined against the spine and the main beams, and slender plate made of foamed resin, and so on. The pairs of points that indicates both end of the respective frame pieces are printed on the kite sheet in advance and double-faced tape of about the same width as that of the respective frame pieces is disposed according to such indications, to paste the respective frame pieces there, for the purpose of providing a kite realized in such a way that it can be assembled quickly and easily. Note that the main beams and the slender plates may be pasted adhesives with releasing paper on them in advance.

The kit is sold depending upon the skill of the purchaser. The most skilled users may buy a kit with white sheet without no pattern and draw the pattern and the form by his/her personal computer. The data of patterns of kite may be installed in a portable memory in the kit, or transmitted to the user's computer from sellers computer responding data transmitted from the user to the seller.

### BACKGROUND OF THE INVENTION

The present invention concerns a kite with improved aviation characteristics, more specifically a kite improved in assembling method.

While a variety of types of kite have been devised from early times and are being used today, kites with improved aviation characteristics were proposed in recent years which were realized by introducing fluid dynamics, aviation dynamics in particular, in the design (see Japanese Bulletin of Laid-Open Patent No. 2000-262772, for example).

FIG. 9-FIG. 11 indicate a kite disclosed in the Japanese Bulletin of Laid-Open Patent No. 2000-262772.

This kite 20 comprises a spine 21, main beams of the wing 22, frame pieces reinforcing the leading 23, frame pieces 24 that set an angle between the spine 21 and the main beams 22, intermediate longitudinal frame pieces 25 that reinforce the wing, frame pieces forming leading edges of the horizontal tail 26, secondary beams 27 to extend the main beam to the outside of 26, braces 28 to reinforce the frames of the wing and kite sheet 29, as main constituent members, and the 21 and the frame pieces 22 are mounted by means of a joint 33 made of resin as shown in FIG. 11(a), while the frame piece 21 and the beam of the wing 24 are fixed together by means of another joint 34 also made of resin.

30 indicates an intermediate reinforcing frame piece for the main wing, while 31, 32 represent wing and horizontal tail respectively.

And, this kite 20 is assembled by first disposing the spine 21 at the center axis of symmetry of the kite sheet 29. Next, the main beams of the wing 22 is disposed perpendicularly to the spine at the point close to the aerodynamic center of the wing 31. The spine 21 and the main beams of the wing 22 are connected to each other by using the joint 33, into a structure bendable around the spine 21. The frame pieces 24 are also connected to the spine in a similar way by using the joints 34. The frame members are pasted to the kite paper 29 and fixed to one another, after they are assembled.

The remaining frame members are also pasted in the same way and, upon completion of the framing, the main frame pieces of the main wing 22 on the left and the right sides are connected at a dihedral angle θ by means of a spring 35 and spring joints 36, 36, as shown in FIG. 10, FIG. 11(b) shows a case in which the spring joint 36 is bent at an obtuse angle for use, but there are also cases where it is bent at an acute angle.

On each joint are provided a plurality of holes or grooves in which to fit the frame members for fixing. The grooves, the section of which is about in U shape, are realized in the shape of a horseshoe with a slightly narrowed inlet so as to fix the frame members there.

By the way, the kite 20 disclosed in the Japanese Bulletin of Laid-Open Patent No. 2000-262772, is composed of many parts. Therefore, it is, though improved in aviation characteristics, requires a certain level of skill and a long time for the assembling work such as connecting the many frame pieces to each other, pasting many pieces on the kite paper by adhesive, etc.

### SUMMARY OF THE INVENTIONS

[Explanation of Parts]

In view of such problems, the objective of the present invention is to provide a kite kit packed necessary parts realized in such a way that it can be sent to users and assembled quickly and easily by users.

To achieve said objective, the kite according to the present invention has the following parts:

(1) A kite sheet that may be unwoven cloth or paper.

(2) A spine serving as the kite's axis of symmetry thet may be a hollow plastic bar or a fiber reinforced material.

(3) Main beams of the wing disposed at higher (up-stream) part of the aerodynamic center of the wing and orthogonal to said spine. These may be fiber reinforced bar or wood with proper cross-sectional form. Note that said main beams may be mounted with spring holders in advance.

(4) Slant beams that set the angle between said main beams and said spine. These may be made of fiber reinforced material or wood.

(5) Longitudinal beams intersecting with said main beams that may be made of fiber reinforced plastic or wood.

(6) Slender plates that may be made of foamed resin and so their weight per unit length is lighter than said beams and said spine. These plates may be used to get rigidity of the leading edge of the wing, to form the horizontal tail and so on.

(7) Secondary beams to extend the wing outside said longitudinal beams in the case that the span of wing is long. These may be made of slender plastic plate and plastic tube laid on it depending upon case.

(8) Bars forming the leading edges of flying birds outside said longitudinal beams that may be made of plastic or fiber reinforced plastic.

(9) Spring holders made of plastic tube.

(10) Protective tape made of plastic with filler such as glass fiber.

(11) A spring that may be made of fiber reinforced plastic and so on.

(12) Double-faced adhesive tapes to paste parts on said sheet.

[Reinforcement of the Intersection Pars of Said Beams and Said Spine]

Protective tapes may be pasted in advance on the kite sheet at the cross point of said main beams and said spine as well as at the cross point of said slant beams and said spine. This prevents the edges of the beams from breaking through the kite sheet. These protective tapes may be pasted by users or by the maker of the kit in advance.

Besides, to fix the ends of slant beams, said slender plates or strong adhesive tapes are pasted over the said slant beams.

[Multiple Use of Double-Faced Adhesive Tape]

The positions where to paste said respective parts are indicated by printing small two points corresponding the both ends of the parts on said kite sheet in advance. The user pastes double-faced adhesive tapes of about the same width as that of the respective parts in the one face on said kite sheet at said positions with releasing paper on the other face. This is also realized in such a way that said adhesive tapes are pasted at the positions where to dispose the respective parts in the one face in advance by the maker on said kite sheet with releasing paper on the other face. In any way, the user peels off the paper, dispose several parts on the respective adhesives. Thus, he can assemble quickly and easily the kite.

To achieve the same objective, said spine with the strings connected, said slant beams, said longitudinal beams, and said bars are pasted by the maker in advance on said sheet. Said main beams with spring holders and said slender plates are coated by adhesives with the releasing paper on it. Even if the user is a beginner, the kite can be assembled quickly by simply peeling off the releasing paper and disposing said main beams and said slender plates on the printed positions respectively.

[Secondary Dihedral Angle]

If the span of wing is long, the kite may be provided, at the end of the main beams, with said secondary beams with bending strength lower than said main beams. This makes it possible for the wing to bend outside said longitudinal beams in strong wind to form secondary dihedral angle that stabilize flight of the kite.

[The Strings]

The string is connected to said spine at two points: the one point is higher (upstream) than the leading edge of the wing and the other lower (downstream) than the point where said slant beams and said spine intersect. This makes it possible to increase virtually the bending strength of said spine. It is noted here that the center of the strings is taken between said two points by a string ring called “slip connecter” at the center of the string so that said kite is effectively a kite with the two strings.

[Use of Face Fastener]

Face fasteners may be pasted on the kite sheet in such a way that they may be symmetrical regarding the kite's axis of symmetry. This makes it possible to raise the end of the horizontal wing from the zero lift line of the wing to remove so-called pitching instability of kite.

[Escaping Danger]

Besides said slender plates may cover the tip of said spine preventing the risk of injuring persons.

[Regarding Spring]

Additionally, at a position near the center portion of said main beams are mounted two spring holders made of plastic tubes symmetrically regarding said spine. It can be, for example, fixed with heat contracting tubes.

A bar-shaped spring is inserted into said spring holders. Note that the length of said spring determines the dihedral angle of the kite.

In that case, the spring may be a bar made of reinforced glass fiber, carbon fiber resin or plastic strong against bending. As a result, no more than necessary wind force is transmitted to the kite through deformation of the spring, even if a large wind force is applied to the kite.

[How to Sell]

The kite may be sold as a kit that packs with necessary parts. This gives the purchaser the pleasure of creation and reduces transportation cost, because it enables a reduction of package size.

Additionally, if a purchaser sends e-mail and tells his desirable kite to the seller, the seller can distribute its kit to the purchaser. This enables the purchaser to buy the kit without taking the trouble of going to the dealer's store.

Plus, it is possible to pack the kite sheet with no pattern and memorize a variety of computer readable pattern images in a portable memory medium, so that the purchaser may print designed patterns on said kite sheet by using a printer connected to his computer. This makes it possible for the purchaser to produce their own kites by selecting their favorite shapes or patterns.

In addition, by handling kite sheet without a pattern, it becomes possible to (a) accumulate a variety of pattern image data in the seller's computer, and (b) transmit such pattern data through the net from the seller's computer, in response to a computer input of designed patterns from the purchaser. This makes it possible for the purchaser to select a wide variety of shapes and patterns preserved on the seller's computer. Needless to say, users may make his original figure and print it in said sheet.

### BRIEF DESCRIPTION OF THE DRAWINGS

FIG. 1 is a back elevation explaining the construction of the kite according to the present invention.

FIG. 2 is a back elevation showing the positions where the slender plates are pasted.

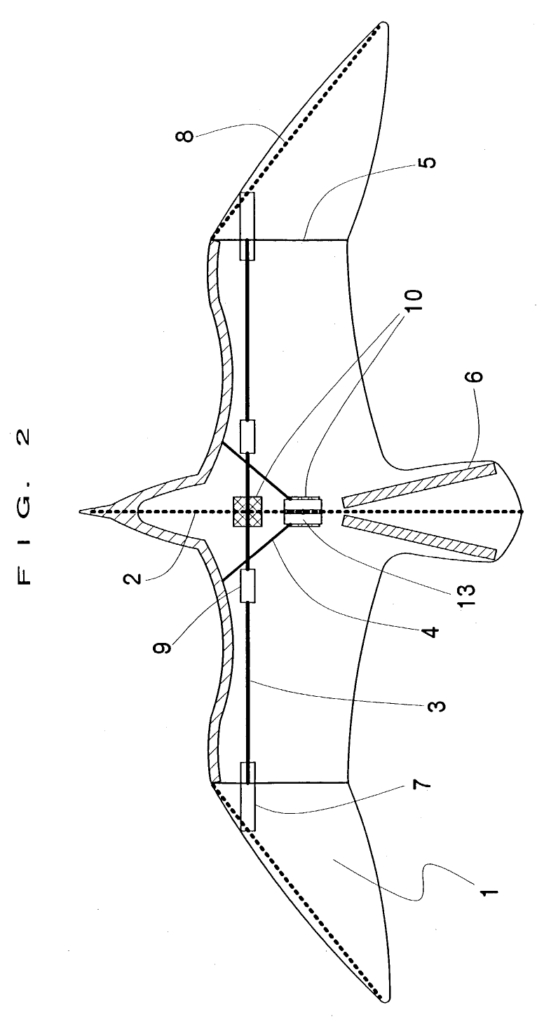

FIG. 3 is a perspective view explaining the relation between adhesive and releasing paper.

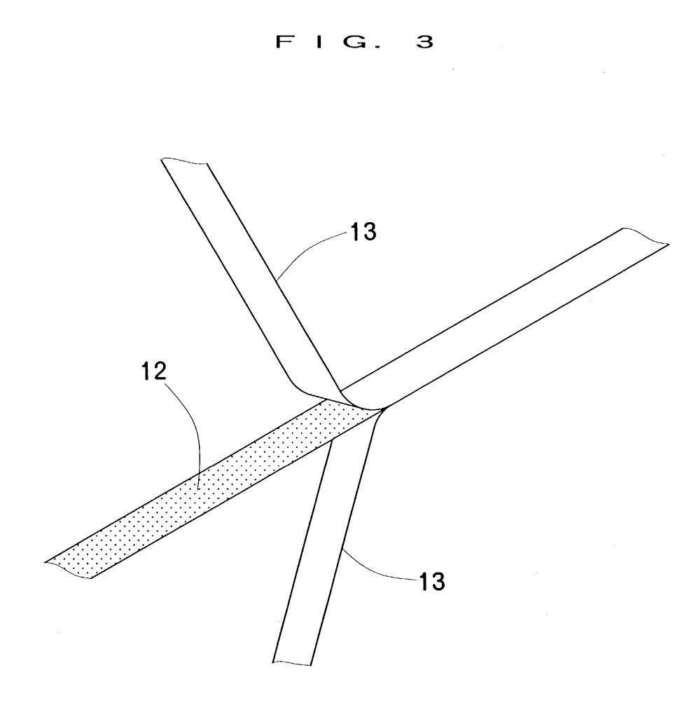

FIG. 4 is an expanded explanatory drawing of the end part of the wing.

FIG. 5 is an expanded view of the portion where the spring is inserted into the spring holders to make a dihedral angle.

FIG. 6 indicating an embodiment of the selling method of kite according to the present invention is an explanatory drawing of selling method utilizing communication circuit such as Internet, etc.

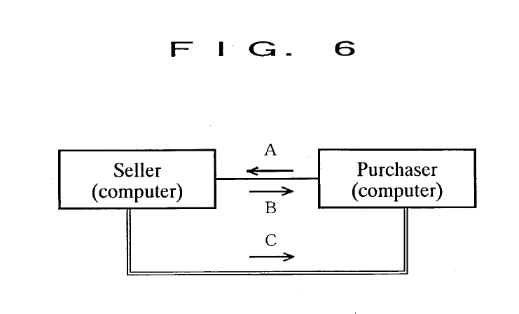

FIG. 7 is a perspective view explaining the construction of empennage utilizing face fastener.

FIG. 8 is a elevation explaining the construction of the kite according to the present invention.

FIG. 9 is a front elevation of a conventional kite.

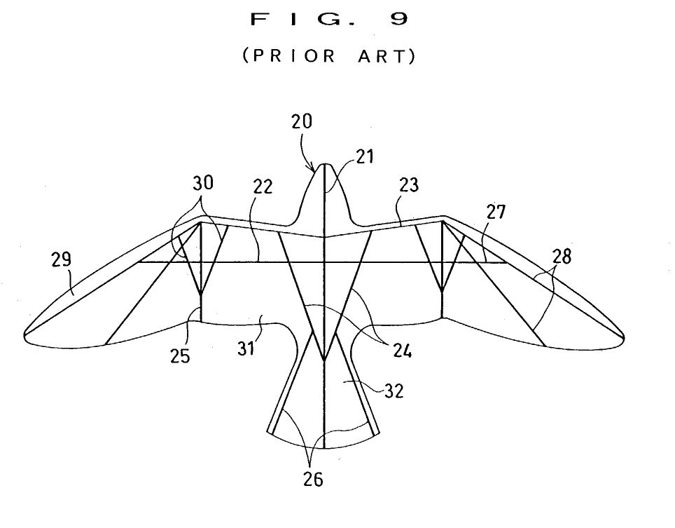

FIG. 10 is a perspective view showing the state in which a spring is installed on a conventional kite.

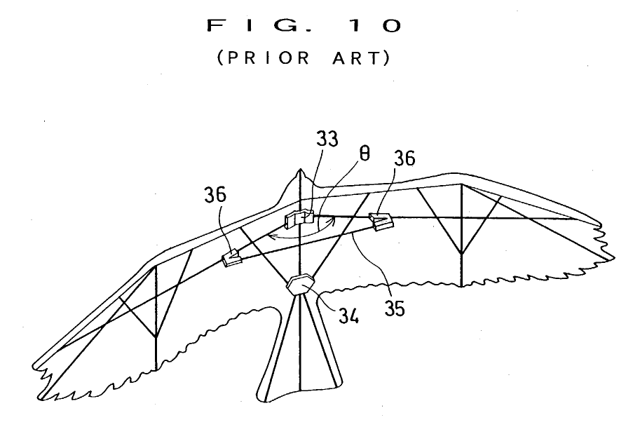

FIG. 11 is a perspective view showing the construction of the joint used for the skeleton of a conventional kite.

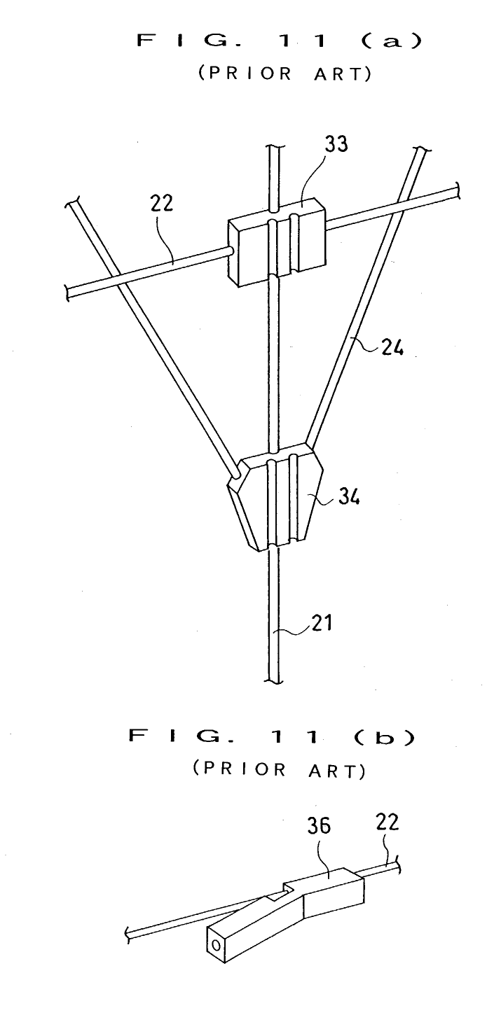

### DETAILED DESCRIPTION OF THE INVENTION

[Construction and Parts]

[Construction]

Embodiments of the kite according to the present invention will be explained below based on drawings.

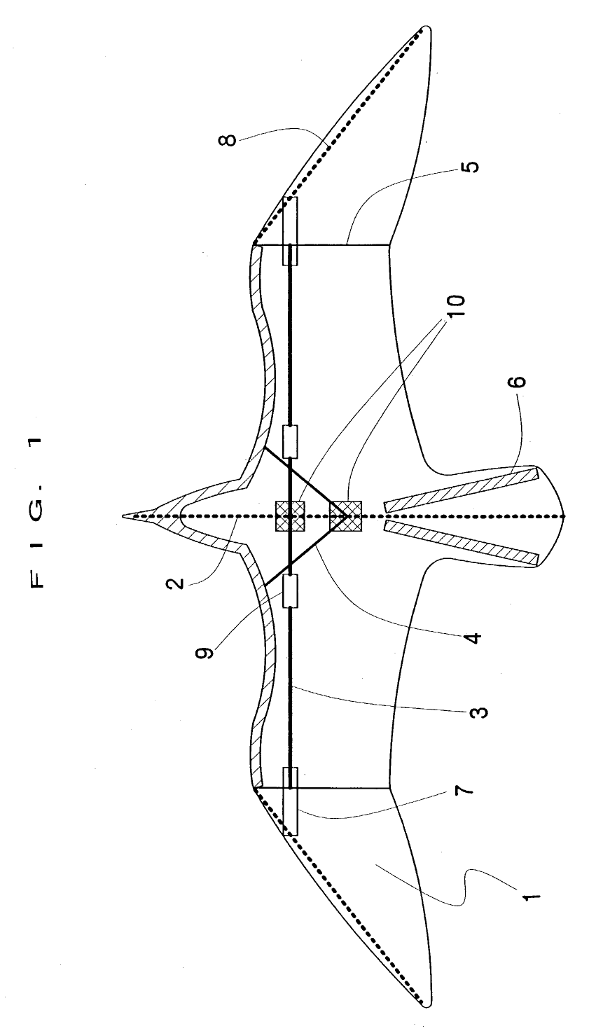

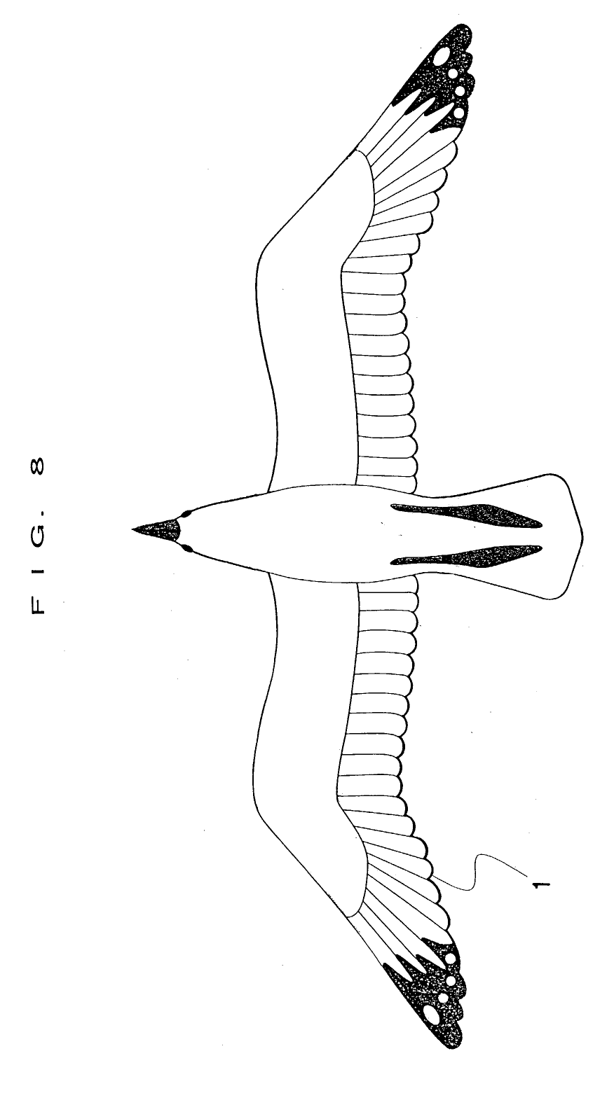

The kite 1 indicated in FIG. 1˜FIG. 8 comprises a spine 2 forming the axis of symmetry of the kite, two main beams 5 with spring holders 9, slender plates 6 for the leading edges of the wing and the horizontal tale, and slant beams 4 are the main parts of the wing that are used in any kite. In addition, longitudinal beams 7 parallel to the spine 2, bars 8 for maintaining the shape of the leading edge at the end of the wing, and secondary beam 7 may be parts of the wing depending on the shape of kite.

It should be pointed here that if said main beams made of wood have cross-section of L or U shape, it can have high ratio of weight per rigidity against bending.

[Use of Double-Faced Adhesive Tape]

As shown in FIG. 1, the above-mentioned parts are pasted on the kite sheet by using double-faced tape of about the same width as that of the respective frame pieces.

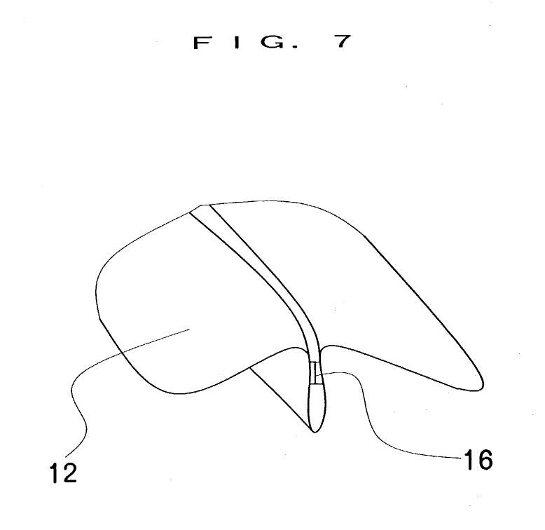

In that case, it may be all right that the maker pastes said spine, said slant beams, said longitudinal beams 7, said outmost leading edges in advance and said secondary beams, folding the sheet pasted with them and send it to the user. The user peels off, as shown in FIG. 7, the releasing paper of double-faced tape whose other side is pasted on the main beams 3 with spring holders 9 and slender plates, and disposes them at the respective positions indicated by two small points printed on the sheet where to dispose them.

[Regarding Secondary Dihedral Angle]

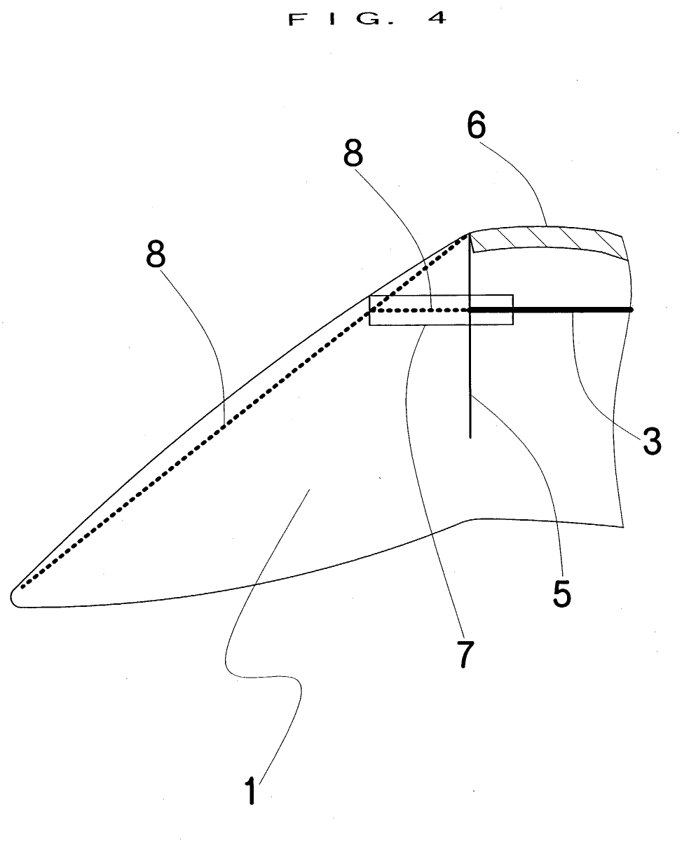

Next, FIG. 4 is an expanded view of end part of the wing. A material of lower rigidity and the form of thin plate are used for the secondary beam 14 at the end part (left side in the illustration) of the main beams 5 with the longitudinal beams 5 as border. For example, a material of high rigidity such as wood or carbon fiber reinforce plastic (hereinafter referred to as CFRP) is used for the main beams, whereas polypropylene plates (hereinafter referred to as PP) of lower rigidity is used for the secondary beam 14.

At that time, it is preferable to mount the main beams and the secondary beams 14 by providing an overlapping portion 1 over the secondary plates 8 with the form of thin plate, as shown in FIG. 4.

Note that, due to this construction, the wing outside the longitudinal beams 5 bends in strong wind forming secondary dihedral angle of the wing and thus stabilizes the flight of kite.

[How to Connect the Strings]

In the kite according to the present invention, the slant beams 6 is made shorter than those of the conventional one, and so the kite string mounting portion 8 below is positioned lower than the cross point of slant beams 6 to secure enough distance between the kite string mounting portions 8 and the upper string mounting points near leading edge to reinforce the bending rigidity of the spine by the tension of the string.

[Protective Tape]

10 in FIG. 1, indicating a protective tape pasted in advance on the intersection of the spine and the slant beams on the kite sheet 1, shall preferably be a tape with filler (fiber), because high pushing forces are impressed at the ends of intersections with spine so that the sheet may be broken through the sheet without protecting tapes. Besides the ends of said slant beams should fixed by pasting said slender plates or other strong adhesive tapes over them.

[Face Fastener]

Still more, as shown in FIG. 7, a face fastener 16 disposed on the horizontal tape 12 with the spine 2 as axis of symmetry, may be used to raise the end of the horizontal wing from the zero lift line of the wing to remove so-called pitching instability of kite.

Yet more, if the face fastener is disposed at the portion of face of the kite (face of a bird in the case where the kite has a shape of a bird as in the illustration), the complete kite after assembling looks better because it becomes as shown in FIG. 8.

[Regarding Spring]

Yet more, bridging the left and right wing is mounted a bar-shaped spring 11 consisting of either reinforced glass fiber, carbon fiber resin, or plastic that are strong for bending.

The length, diameter and rigidity of the spring 11 are of such a level as to be greatly deformed, in case any wind force exceeding the limit of tolerance is applied to the main beams of the wing, to prevent application of any further wind pressure to said main beams 3 and, in the case where the surface area of wings of the kite is no more than 1.2 m2, for example, they shall preferably be of a level to be greatly deformed, in case of application of a wind force equivalent to the limit of strength of a sewing thread #100 of polyester of nylon to the kite, to prevent application of any further wind pressure to the kite paper.

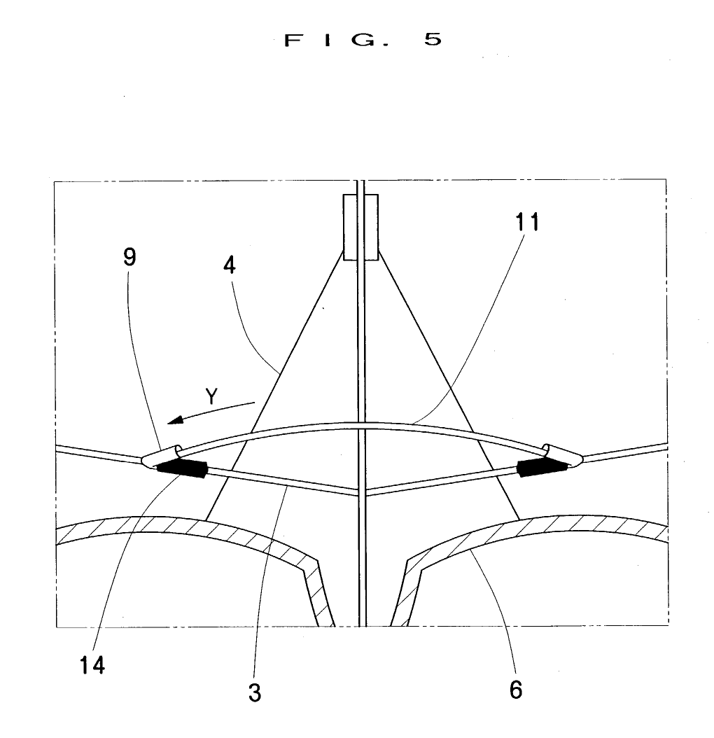

This bar-shaped spring 11 is disposed symmetrically against the spine 2 at a position near the central part of the main beams 3, as shown in FIG. 5, and, at this time, a spring holder 9 of hollow structure fixed with a heat contracting tube 14 is bent inward, as shown in FIG. 5, to mount the bar-shaped spring 11 in such a way that it can be inserted from the direction of arrow mark Y.

[Selling Method]

[Packaging as a Kit]

Next, explanation will be made of the selling method of the kite according to the present invention.

The selling method of the kite according to the present invention consists in selling said kite as a kit that includes necessary parts and materials.

[Kit for Beginners]

The kit recommendable to a beginner is a kit with the following parts:

(1) Kite sheet pasted the spine attached with the strings, slant beams, longitudinal beams, secondary beams and outmost leading edge in advance and the small marks to indicate the both ends of the respective parts are printed on the sheet. Note that this sheet can be packed compactly by folding it.

(2) The main beams with the spring holders with a spring fixed in one holder and the slender plates for forming the leading edge and the form of horizontal tail that are cut by proper curves or given length and pasted by adhesives with releasing paper on it.

[Kit for the Person Who is Not a Beginner]

The kit for customer who has made the kite more than once may be the kit by which a plurality of kinds of kite can be assembled.

Since a plurality of kinds of kite can be assembled by the kit, the length of the respective parts are adjusted to the largest pattern to be expressed on the kite sheet, for example, the respective parts may be used by cutting shorter than the packed one when utilizing any patterns.

Moreover, the purchaser may make a kite of his taste, if the sheet pieces constituted by foamed resin sheet members are packed depending on a plurality of kinds of pattern, or packed in the form of sheet.

[Utilization of the Internet]

Furthermore, the selling method of the kite according to the present invention consists in that the purchaser inputs a kite of desired size on the computer and transmits it to the seller's computer as data A from the personal computer in his house through either Internet circuit or e-mail, for example, as shown in FIG. 8.

The seller, on his part, distributes a kite conformable to such data to the purchaser, through the route C. The seller accumulates sizes and patterns of the kites in the memory medium of his computer and makes such data A available for inspection to the purchaser and makes him input necessary data, or it may also be all right for the seller to issue a catalogue or booklet describing the sizes and patterns of the kites available for sale in advance so that the purchaser may input data A with reference to such description. In that case, the purchaser may inform the seller of the desired size by post card or facsimile or transmit the data of desired kite by utilizing the telephone number guide service of general telephone circuit, without using personal computer.

[Creation of New Kite by User]

In the selling method described above, the sales may be made by providing the kite sheet in a kit without pattern and attach a portable memory medium, readable on computer, memorizing a variety of patterns and images in the kit.

At that time, the kite sheet without pattern shall preferably be packaged in the state split into sheets of A4 size that are printed by the most common printer driven by personal computers for general household use.

Still more, in the selling method described above, the kite sheet in the set may be provided without pattern, to enable the purchaser to input desired pattern on the computer by selecting from among a variety of pattern and image data stored in the seller's computer, from his own personal computer for example, by utilizing either Internet circuit or e-mail, and transmits it to the seller's computer as data A.

The computer on the seller's side transmit pattern data corresponding to such data as data B from seller's computer to the purchaser's computer, and (the purchaser) may print that data for use by using a personal computer in his house.

At that time, instead of storing said data in the seller's computer, the seller may issue a catalogue or booklet describing a variety of patterns in advance so that the purchaser may input data from the issued catalogue or booklet.

Needless to say, the most advanced user may make his original form and pattern by making use of his personal computer, scanner and printer.

The kite and the selling method of kite according to the present invention have so far be explained based on their embodiments, but the present invention is not restricted to the constructions indicated in said embodiments and may be change in construction as required in the range not deviating from the main purpose of the invention.

1. A kite comprising a spine serving as the kite's axis of symmetry, the main beams of the wing disposed at the position higher (upstream) than the aerodynamic center of the wing and orthogonal to said spine, and slant beams, characterized in that the positions where to dispose said respective parts are indicated on the kite sheet in advance by printing two points corresponding both end of the frame pieces and that double-faced tape of about the same width as that of the respective frame pieces is disposed according to such indications, so that said respective frame pieces may be pasted there.

2. A kite comprising a spine serving as the kite's axis of symmetry, the main beams of the wing disposed at the position higher (upstream) than the aerodynamic center of the wing and orthogonal to said spine, and slant beams, characterized in that the portions of the kite sheet corresponding to the intersection of the spine and slant beams and those of the main beams are pasted in advance with strong tapes reinforced with filler or glass fiber.

3. A kite comprising a spine serving as the kite's axis of symmetry, the main beams of the wing disposed at the position higher (upstream) than the aerodynamic center of the wing and orthogonal to said spine, and slant beams, characterized in that the spine, the longitudinal beams, secondary beams and the outermost leading edges are pasted in advance, and the main beams with spring holders and the slender plates of foamed resin are pasted in advance with adhesives with releasing papers on it.

4. A kite comprising a spine serving as the kite's axis of symmetry, the main beams of the wing disposed at the position higher than the aerodynamic center of the wing and orthogonal to said spine, and slant beams, characterized in that adhesive is coated with releasing paper on it in advance at the positions where to dispose said respective frame pieces on the kite sheet, allowing pasting of said respective frame pieces by peeling off the releasing paper.

5. A kite comprising a spine serving as the kite's axis of symmetry, the main beams of the wing disposed at the position higher than the aerodynamic center of the wing and orthogonal to said spine, and slant beams, characterized in that the secondary beams of thin plate with lower rigidity are set being overlapped with the main beams under these to extend the width of the main wing, and the length of the secondary beams are long, the plastic pipe used for the spine may be disposed on the thin plate.

6. A kite comprising a spine serving as the kite's axis of symmetry, the main beams of the wing disposed at the position higher than the aerodynamic center of the wing and orthogonal to said spine, and slant beams, characterized in that the lower mounting point of the kite string to be fixed on the spine is provided at a position lower than the point where the slant beams and the spine intersect.

7. A kite comprising a spine serving as the kite's axis of symmetry, the main beams of the wing disposed at the position higher than the aerodynamic center of the wing and orthogonal to said spine, and slant beams, characterized in that the kite is provided, at the end of the main beams, with longitudinal beams intersecting with the main beams, and the longitudinal beams consist of material having about the same strength and rigidity as the slant beams.

8. A kite comprising a spine serving as the kite's axis of symmetry, the main beams of the wing at the position higher than the aerodynamic center of the wing and orthogonal to said spine, and slant beams, characterized in that face fasteners are symmetrically pasted on the kite paper against the kite's axis of symmetry.

9. A kite comprising a spine serving as the kite's axis of symmetry, the main beams of the wing disposed at the position higher than the aerodynamic center of the wing and orthogonal to said spine, and slant beams, characterized in that at the leading edge portion of the wing is mounted a light straight or curved slender plates made of foamed resin having the required rigidity.

10. A kite comprising a spine serving as the kite's axis of symmetry, the main beams of the wing disposed at the position higher than the aerodynamic center of the wing and orthogonal to said spine, and slant beams, characterized in that the intersection of the spine and the slant beams are symmetrically pasted for example by two slender plates of foamed resin with adhesives in its one face mounting the slant beams, and any strong tape can be used in place of the slender plate.

11. A kite comprising a spine serving as the kite's axis of symmetry, the main beams of the wing disposed at the position higher than the aerodynamic center of the wing and orthogonal to said spine, and slant beams, characterized in that the cross-section main beams has L or U shape.

12. A kite as defined in claim 11, wherein at a position near the center portion of the main beams may be symmetrically mounted a spring holder fixed with a heat contracting tube against the spine, to hold a bar-shaped spring with this spring holder of plastic tube.

13. A kite as defined in claim 12, wherein the spring is a bar made of reinforced glass fiber plastic or bar made of plastic strong against bending like PP.

14. For a beginner, the seller sells a kit with the following parts:
(a) The sheet pasted in advance with the spine attached with the strings, slant beams, longitudinal beams, secondary beams and outmost leading edge. Note that this sheet can be packed compactly by folding it.
(b) The main beams with the spring holders with a spring fixed in one holder and the slender plates for forming the leading edge and the form of horizontal tail are cut by given length and pasted by adhesives with releasing paper on it. Pairs of small points that show the both end of them are printed on the sheet.

15. For a user who has assembled the kite at least once, the seller may sell a kit that packs:
(a) The sheet with a requested pattern are coated by Adhesive with releasing paper on it in advance at the positions where to dispose the spine attached with the strings, slant beams, longitudinal beams, secondary beams and outmost leading edge.
(b) Material of main beams with spring holders is pasted with adhesives with releasing paper on it.
(c) Its length is adjusted to the largest pattern to be described on the kite sheet.
(d) Material of the spine and that of outmost leading edge that may be plastic tube and material for leading edges and slender plats.
(e) They have length that is also adjusted to the largest pattern to be described on the kite sheet.

16. For a user who has assembled the kite at least once, the seller may sell a kit that packs:
(a) The sheet are printed not only with a requested pattern but also the pairs of small marks the indicate the positions of both ends of the spine with the strings connected, slant beams, longitudinal beams, secondary beams and outmost leading edge.
(b) Material of main beams with spring holders is pasted with adhesives with releasing paper on it. Its length is adjusted to the largest pattern to be described on the kite sheet.
(c) Material of the spine and that of outmost leading edge that may be plastic tube, material for leading edges and slender plats, and double-faced tape of about the same width as that of the respective frame pieces, double-faced tape of about the same width as that of the frame pieces.
(d) They have length that is also adjusted to the largest pattern to be described on the kite sheet.

17. For a user who has made many kites and want to make his original kite, the seller may sell a kit that packs:
(a) Sheets of A4 size that are printed by the most common printer attached to personal computers for general household use.
(b) Material of main beams with spring holders is pasted with adhesives with releasing paper on it. Its length is adjusted to the largest pattern to be described on the kite sheet.
(c) Material of main beams with spring holders is pasted with adhesives with releasing paper on it.
(d) Its length is adjusted to the largest pattern to be described on the kite sheet.

18. A selling method for the kite, characterized in that the seller distributes the respective constituent materials of the kite to the purchaser, based on a computer input of the kite desired from the purchaser.

19. A selling method for the kite as defined in claim 17, wherein the kite sheet has no pattern, and a variety of computer readable pattern images are memorized in a portable memory medium in the kit, so that the purchaser may print designed patterns on said kite paper by using a printer connected to his/her computer.

20. A selling method for the kite as defined in claim 17, wherein
(a) a variety of patterns and image data are stored in the seller's computer, and,
(b) responding to computer input of a desired pattern from the purchaser, the data of the pattern concerned is transmitted from the seller's computer.
